(19) United States
(12) Patent Application Publication
(10) Pub. No.: US 2025/0303814 A1
(43) Pub. Date: Oct. 2, 2025

(54) DEVICE FOR REGULATING A THROUGH-FLOW AND DISTRIBUTING A FLUID IN A FLUID CIRCUIT

(71) Applicant: Hanon Systems, Daejeon (KR)

(72) Inventors: Márton Földesi, Székesfehérvár (HU); Zoltán Horváth, Iszkaszentgyörgy (HU); Zsolt Literáti, Székesfehérvár (HU); István Pajor, Székesfehérvár (HU)

(21) Appl. No.: 19/097,406

(22) Filed: Apr. 1, 2025

(30) Foreign Application Priority Data
Apr. 2, 2024 (DE) 102024109198.3
Jan. 8, 2025 (DE) 102025100382.3

(51) Int. Cl. B60H 1/00; F16K 5/06; F16K 27/06

(52) U.S. Cl. CPC B60H 1/00485; F16K 5/0605; F16K 5/0689; F16K 27/067

(57) ABSTRACT

A device for regulating a through-flow and distributing a fluid in a fluid circuit, in particular a refrigerant in a refrigerant circuit. The device has a housing with fluid connections, which are each connected via a passage opening to an inner volume of the housing formed as a valve chamber, and a valve element with a through-flow opening and a valve seat element, which are arranged within the valve chamber. The valve element is mounted within the valve seat element so as to be rotatable about an axis of rotation and is arranged abutting the valve seat element. The valve seat element is arranged abutting the housing. Exactly one sealing element for sealing the valve seat element to the housing is provided between the valve seat element and the housing.

### CROSS REFERENCE TO RELATED PATENT APPLICATIONS

This patent application claims the benefit of and priority to German Patent Application No. DE 10 2025 100 382.3, filed on Jan. 8, 2025, and German Patent Application No. DE 10 2024 109 198.3 filed Apr. 2, 2024, the entire contents of each of which are incorporated herein by reference for all purposes.

### TECHNICAL FIELD

The invention relates to a device for regulating a through-flow and distributing a fluid in a fluid circuit, in particular a refrigerant in a refrigerant circuit. The device has a housing with fluid connections which are each connected via a passage opening to an inner volume of the housing formed as a valve chamber, and a valve element with a through-flow opening and a valve seat element which are arranged within the valve chamber. The invention also relates to a use of the device in a refrigerant circuit of a thermal system, in particular of a motor vehicle.

### BACKGROUND ART

In motor vehicles known from the prior art, a high requirement for the comfort of the passengers in the passenger compartment is met by air-conditioning systems with different circuits for refrigerant and coolant, each with differently operated heat exchangers. Refrigerant circuits of conventional air-conditioning systems can be formed to be operable both in a mode as a heat pump and in a mode as a refrigeration system in order to distribute thermal energies within the motor vehicle.

For example, in particular when operating the refrigerant circuit in a heat pump mode, heat can be transferred from the ambient air by means of a refrigerant-air heat exchanger or heat can be transferred from a coolant circuit to the refrigerant by means of a refrigerant-coolant heat exchanger, which heat can then be delivered to components of the motor vehicle with a heat demand or to the supply air to the passenger compartment. The refrigerant-air heat exchanger or the refrigerant-coolant heat exchanger are each operated as an evaporator for the refrigerant.

During operation of the refrigerant circuit in a refrigeration system mode, heat can be absorbed from the passenger compartment or from the supply air to the passenger compartment or other components and transferred to the environment, for example in the refrigerant-air heat exchanger. In this case, the refrigerant-air heat exchanger is operated as a condenser or possibly also as a gas cooler. Another refrigerant-air heat exchanger operated as an evaporator serves to dehumidify or cool the supply air to the passenger compartment.

The device for regulating the through-flow and distributing the fluid in the fluid circuit, when employed in a refrigerant circuit, can in each case also fulfil the function of expanding the refrigerant to the evaporation pressure.

In order to be able to operate the heat exchangers in various functions, for example as an evaporator on the one hand and as a condenser/gas cooler of the refrigerant on the other hand, depending on the operating mode of the air-conditioning system, in particular of the refrigerant circuit, the corresponding heat exchangers are integrated at different points within the refrigerant circuit and are thus acted upon by refrigerant in different states.

Two-way valves known from the prior art can have differently formed flow paths, also referred to as topology. In the case of a linear topology, the fluid connections of the two-way valve for connection to fluid lines and thus other components of the fluid circuit are arranged on opposite sides of the housing, symmetrically with respect to a central plane of the valve which is aligned perpendicularly to the direction of the substantially rectilinear flow path. The flow path for the fluid has a linear shape in the open position of the valve.

Inner sealing elements, such as a valve seat element formed as a sealing seat and sealing elements formed as an O-ring, for example, are arranged on opposite sides of an in particular spherical valve element, corresponding to the position of the fluid connections of the housing, as passage openings to the valve chamber. The inner sealing elements of the valve seat element and sealing elements are each arranged in the region of a fluid connection between the housing and the valve element and seal the valve element to the housing in a fluid-tight manner.

In addition to the function of sealing the valve element to the housing, the inner sealing elements also fulfil the function of mechanically guiding the valve element within the valve chamber of the housing. The inner sealing elements also ensure, in particular, an internally fluid-tight closed position of the valve.

DE 10 2020 211 278 A1 discloses a valve, in particular an expansion valve, for controlling a fluid mass flow, specifically a refrigerant mass flow. The valve has a housing with a receiving space and at least two fluid channels connected to the receiving space, and a valve element arranged in the receiving space. The housing is formed with an opening which preferably runs perpendicularly to the fluid channels and opens into the receiving space. A sealing ring holder for receiving sealing rings and for guiding the valve element is arranged within the receiving space. The sealing ring holder with the valve element accommodated therein can be inserted into the receiving space through the opening designed in the housing. The valve element is rotatably mounted in the sealing ring holder by means of two sealing rings formed as a sealing seat. The two sealing rings of the sealing seat which face the fluid channels and are thus arranged on opposite sides of the valve element in connection with a sealing element formed as an O-ring serve the fluid sealing of the valve element to the housing. The sealing elements are each arranged between a sealing ring and the housing. The valve element is formed with a straight through-flow opening.

In addition to forming a linear topology of the valve with a rectilinear flow path through a valve element in the open position of the valve, the fluid connections can also be arranged on the housing at a 90° angle to one another, depending on the requirement. The flow path for the fluid has an L-shape in the open position of the valve, in particular through the valve element.

The inner sealing elements, such as valve seat element and sealing elements, are arranged on opposite sides of the in particular spherical valve element, between the housing and the valve element, primarily for reasons of mechanical guidance of the valve element, as in the case of a valve with a linear topology. In this case, however, on the one hand of the spherical valve element, a partial volume of the valve chamber in which the valve element and the sealing elements are arranged is separated off as a cavity sealed to the valve chamber. During operation of the valve, the sealed cavity is filled with a portion of the fluid flowing through the valve, which fluid accumulates in the cavity and is enclosed within the cavity. Due to changing operating conditions, undesired pressure differences can occur between the fluid portion within the volume of the valve chamber and the fluid portion enclosed in the cavity separated from the valve chamber, which can lead to malfunctions of the valve and damage to the valve.

### SUMMARY

The object of the invention is to provide a device for regulating a through-flow and distributing a fluid in a fluid circuit, in particular in a refrigerant circuit, of a thermal system of a motor vehicle. The device is to be formed such as to avoid malfunctions and damage, in particular due to pressure differences occurring, and thus to maximise operational reliability and service life. The device should have a simple and compact design with a minimum number of components and minimum manufacturing costs and assembly costs.

The object is achieved by the subject matters with the features shown and described herein.

The object is achieved by a device for regulating a through-flow and distributing a fluid in a fluid circuit, in particular a refrigerant in a refrigerant circuit. The device has a housing with fluid connections, which are each connected via a passage opening to an inner volume of the housing formed as a valve chamber, as well as a valve element with a through-flow opening and a valve seat element, which are arranged within the valve chamber.

According to the concept of the invention, the valve element is mounted within the valve seat element such that it can rotate about an axis of rotation and is arranged abutting the valve seat element. The valve seat element for receiving the valve element, for sealing the valve element to the housing and for mechanically guiding the valve element is arranged abutting the housing and supported by the housing. Exactly one sealing element for sealing the valve seat element to the housing is arranged within the valve chamber between the valve seat element and the housing.

Exactly one sealing element for sealing the valve seat element to the housing is to be understood as meaning that exclusively and only this single and individual sealing element is provided within the valve chamber between the valve seat element and the housing.

According to a further development of the invention, the housing has exactly two fluid connections, a first fluid connection and a second fluid connection. The exactly one sealing element for sealing the valve seat element to the housing is advantageously arranged in the region of the first fluid connection, facing the passage opening of the first fluid connection formed in the housing. The exactly one sealing element is preferably formed as an O-ring which completely surrounds the passage opening of the first fluid connection.

According to a preferred design of the invention, the fluid connections are arranged on sides of the housing which differ from one another. The first fluid connection is formed on a side wall of the housing and the second fluid connection is formed on an end face of the housing.

Axes of symmetry of the fluid connections are preferably arranged within a common central plane of the device in which the axis of rotation of the valve element also extends. The axes of symmetry of the fluid connections are preferably aligned with respect to one another at an angle different from zero, in particular at an angle of 90°.

A further advantage of the invention is that the axis of symmetry of the first fluid connection is aligned perpendicularly to the axis of rotation of the valve element and the axis of symmetry of the second fluid connection is aligned in the direction of the axis of rotation of the valve element. The axis of rotation of the valve element runs in particular in the direction of a longitudinal axis of the device and can be arranged coaxially to the longitudinal axis of the device so that the axis of rotation of the valve element and the longitudinal axis of the device are identical.

According to a further advantageous design of the invention, the valve element is substantially formed to be spherical. With the formation of the through-flow opening, the valve element deviates from the spherical shape in the region of the surface with the opening through-flow opening.

According to a further development of the invention, the through-flow opening of the valve element has an L-shape or an L-topology which, in the opened state of the device, connects the passage openings of the fluid connections to one another. With the rotation of the valve element about the axis of rotation, the valve element is advantageously movable between two end positions. In a first end position, in particular, the flow cross-section of the passage opening of the first fluid connection is substantially closed, while in a second end position of the valve element, the device is completely opened, specifically the passage openings of the fluid connections and the through-flow openings of the valve element provide an open flow path. In the first end position, the flow path is opened only in the region of a groove, also referred to as an expansion notch, which is formed on the surface of the valve element. The device is thus formed in particular as a two-way valve with an L topology, specifically as a two-way refrigerant valve.

The device can be configured such that the fluid is expanded when flowing through the device.

A further advantage of the invention is that the housing has an opening through which the valve seat element with the valve element arranged therein and the one sealing element is arranged in a direction perpendicularly to the axis of rotation of the valve element and introduced into the valve chamber. The housing preferably has a closure element for closing this opening in a fluid-tight manner.

The exactly one sealing element for sealing the valve seat element to the housing is preferably arranged between the valve seat element and the closure element of the housing.

According to a further preferred design of the invention, the valve element for moving the valve element relative to the housing is connected to a drive element arranged outside the housing via an actuator element.

The actuator element is preferably formed as a drive shaft aligned in the direction of the axis of rotation of the valve element. The actuator element is connected fixedly to the valve element, in particular at a first end, and to the drive element, projecting out of the housing, at a second end distally to the first end.

A drive element, which is provided in particular as a rotary motor, is preferably formed as an electric actuating motor, in particular as a stepper motor or servomotor, which advantageously permits, for example, the control of the angular position. The motor can be formed with a sensor for position determination. The rotational position of the actuator element determined by the sensor can be transmitted continuously to an electronic control system which regulates the movement of the motor in a control circuit according to adjustable desired values, such as desired angular positions of the actuator element.

The employment of such a device in a refrigerant circuit of an air-conditioning system, in particular of motor vehicles, often requires a bidirectional flow through at least some components since the flow direction of the refrigerant within the refrigerant circuit, for example between the operating modes of refrigeration system operation and heat pump operation, also referred to as heating operation, is reversed. The device can also fulfil this function and be flown through in two directions or bidirectionally if no internal tightness is required.

The arrangement of the only one sealing element for sealing the valve seat element to the housing within the valve chamber prevents the formation of closed volumes or cavities which are in particular separated from the valve chamber. Due to the formation of an open cavity as a partial volume of the valve chamber, the valve seat element can be moved within the volumes of the cavity and the valve chamber in the event of pressure changes of the fluid as a result of the pressure within the cavity or of the pressure difference of the fluid within the volumes of the cavity and the valve chamber, so that the cavity is opened and the pressure of the fluid within the volumes is compensated. By dispensing with further sealing elements, the housing design is also simplified in comparison with devices known from the prior art.

Due to the automatic pressure compensation within the device, malfunction and damage of the device are prevented.

The asymmetrical arrangement of the single sealing element for sealing the valve seat element to the housing also has no influence on the sealing internal to the device since the device is formed without an internal closed position and is always arranged in an opened position, first end position “expansion mode” and second end position “completely opened”. The internal tightness is not required.

The advantageous design of the invention enables the use of the device for regulating a through-flow and distributing a fluid in a refrigerant circuit of a thermal system, in particular a thermal management system, of a motor vehicle, for example for conditioning an air mass flow to be supplied to a passenger compartment or a component of a drive train.

The refrigerant circuit in which a device according to the invention is used can be operated with any desired refrigerant, in particular R1234yf, R1234a, R134a, R404a, R600 or R600a, R290, R152a, R32 and mixtures thereof.

In summary, the device according to the invention has various advantages, in particular as a two-way refrigerant valve:
combining different valve functions, in particular of two valves, specifically shut-off valve and expansion valve,
reduced complexity leads to simple assembly,
avoiding malfunctions of the valve and damage to the valve and thus a long service life; and
minimum manufacturing, maintenance and operating costs.

The invention relates to a device for regulating a through-flow and distributing a fluid in a fluid circuit, in particular a refrigerant in a refrigerant circuit. The device has a housing with fluid connections which are each connected via a passage opening to an inner volume of the housing formed as a valve chamber, and a valve element with a through-flow opening and a valve seat element which are arranged within the valve chamber. The invention also relates to a use of the device in a refrigerant circuit of a thermal system, in particular of a motor vehicle.

### DESCRIPTION OF DRAWINGS

Further details, features and advantages of designs of the invention will become apparent from the following description of an exemplary embodiment with reference to the associated drawings. Wherein:

FIG. 1: shows a device for regulating a through-flow and distributing a fluid in a fluid circuit in an opened state with a housing with two fluid connections and a valve element with a through-flow opening of a flow path of linear topology and internal sealing elements from the prior art in a lateral sectional representation,

FIG. 2a: shows a device according to the invention for regulating a through-flow of a fluid in a fluid circuit, in particular of a refrigerant in a refrigerant circuit of an air-conditioning system of a motor vehicle, in a closed state with a housing with two fluid connections and a valve element arranged within the housing in a lateral sectional representation,

FIG. 2b: shows a detailed view of the device of FIG. 2a with the housing and the valve element with a through-flow opening of a flow path in an L-shape and inner sealing elements in a lateral sectional representation,

FIG. 3a: shows the device from FIG. 2a in an opened state in a lateral sectional representation and

FIG. 3b: shows the device from FIG. 2a in an opened state in a sectional representation of a plan view.

### DESCRIPTION OF AN EMBODIMENT

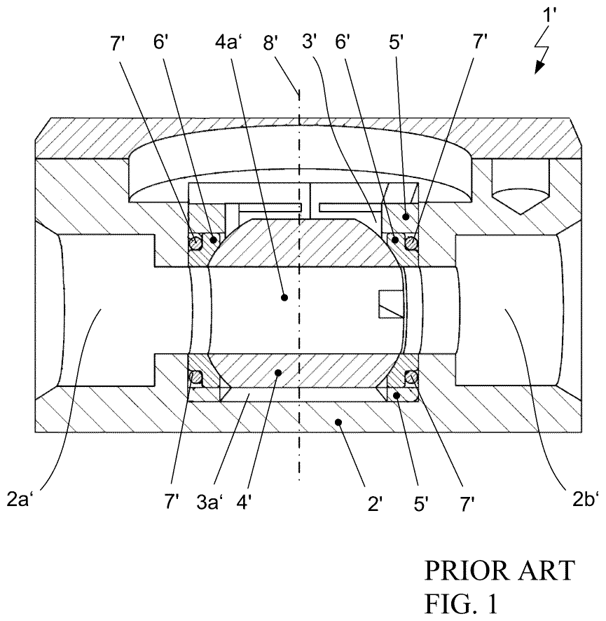

FIG. 1 shows a device 1′ for regulating a through-flow and distributing a fluid in a fluid circuit, in particular a two-way refrigerant valve, in an opened state with a housing 2′ with two fluid connections 2a′, 2b′ for connecting to fluid lines of the fluid circuit and a substantially spherical valve element 4′ from the prior art arranged within a valve chamber 3′ in a lateral sectional representation. The valve element 4′ has a through-flow opening 4a′ of a flow path of linear topology and inner sealing elements. The fluid connections 2a′, 2b′ and the valve chamber 3′ are each connected to one another via a passage opening formed in the housing 2′ which opens into the valve chamber 3′. The fluid connections 2a′, 2b′ are arranged on opposite sides of the housing 2′, symmetrically with respect to a central plane which is aligned perpendicularly to the direction of the substantially rectilinear flow path.

A holding element 5′ for receiving ring elements 6′ for sealing the valve element 4′ to the housing 2′ and for mechanically guiding the valve element 4′ and for receiving sealing elements 7′ for sealing the holding element 5′ to the housing 2′ is arranged within the valve chamber 3′. The holding element 5′ can be introduced into the valve chamber 3′ with the ring elements 6′ and the valve element 4′ arranged therein as well as the sealing elements 7′ through an opening formed in the housing 2′ in the direction of a central axis of the device 1′.

The valve element 4′ is rotatably mounted within the holding element 5′ about an axis of rotation 8′, which corresponds to the central axis of the device 1′, by means of the two ring elements 6′ formed as a sealing seat. The ring elements 6′ each face the passage openings formed in the housing 2′ and are thus arranged on opposite sides of the valve element 4′ corresponding to the position of the fluid connections 2a′, 2b′ of the housing 2′. The ring elements 6′, each in connection with a sealing element 7′ formed as an O-ring, as so-called inner sealing elements, server the fluid sealing of the valve element 4′ to the housing 2′. The sealing elements 7′ are each arranged between a ring element 6′ and the housing 2′. The inner sealing elements also ensure, in particular, an internally fluid-tight closed position of the device 1′.

The valve element 4′ has a rectilinear through-flow opening 4a′ and thus a through-flow opening 4a′ with a linear shape which, in the opened state of the device 1′, connects the passage openings of the fluid connections 2a′, 2b′ to one another. Axes of symmetry of the first fluid connection 2a′ and of the second fluid connection 2b′ are aligned on a common axis and in each case perpendicularly to the axis of rotation 8′ of the valve element 4′ and thus perpendicularly to the central axis of the device 1′.

A cavity 3a′ separated from the valve chamber 3′ is formed as a partial volume of the valve chamber 3′, which is acted upon by refrigerant, between the housing 2′, the valve element 4′ and the holding element 5′ of the ring elements 6′.

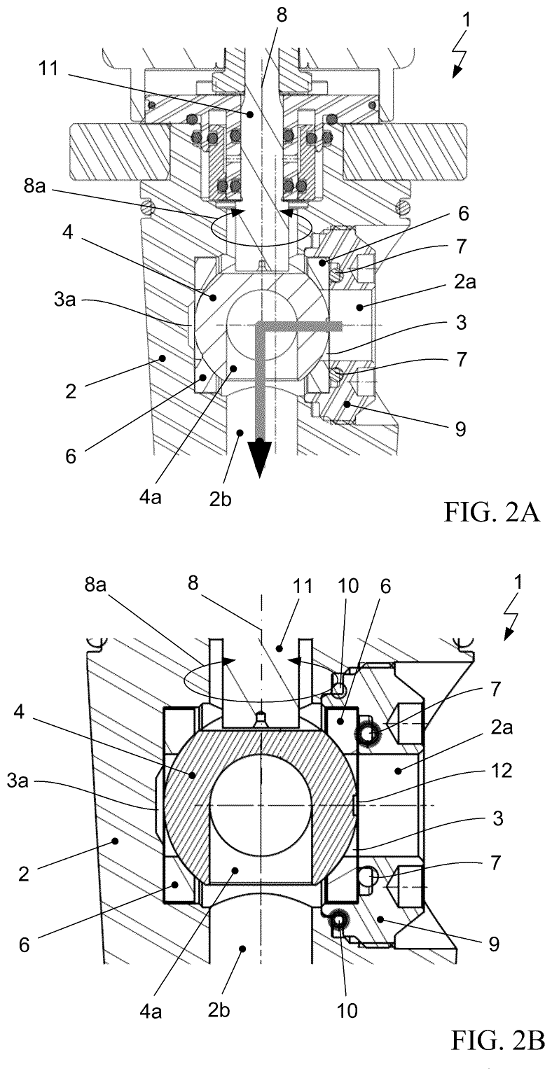

FIG. 2a reveals a device 1 for regulating a through-flow of a fluid in a fluid circuit, in particular a two-way valve for a refrigerant in a refrigerant circuit of an air-conditioning system of a motor vehicle, in a state of expansion of the fluid with a housing 2 with two fluid connections 2a, 2b and a substantially spherical valve element 4 arranged within a valve chamber 3 of the housing 2 in a lateral sectional representation. FIG. 2b shows a detailed view of the device 1 from FIG. 2a with the housing 2 and the valve element 4 with a through-flow opening 4a of a flow path in an L-shape and inner sealing elements in a lateral sectional representation. The valve element 4 is rotatably mounted about an axis of rotation 8 which corresponds to the central axis or the longitudinal axis of the device 1.

The valve element 4 has a through-flow opening 4a of a flow path of an L-topology and inner sealing elements. The fluid connections 2a, 2b and the valve chamber 3 are each connected to one another via a passage opening in the shape of a flow channel which is formed in the housing 2 and opens into the valve chamber 3.

A first fluid connection 2a is arranged on a first side of the housing 2, while a second fluid connection 2b is arranged on a second side of the housing 2. The fluid connections 2a, 2b are aligned with respect to one another at an angle, in particular at an angle of 90°, within a central plane of the device 1 in which the axis of rotation 8 also runs, so that the first fluid connection 2a is formed on a side wall of the housing 2 and the second fluid connection 2b is formed on an end face of the device 1. An axis of symmetry of the first fluid connection 2a is aligned perpendicularly to the longitudinal axis of the device 1, while an axis of symmetry of the second fluid connection 2b is aligned in the direction of the longitudinal axis of the device 1, which in particular corresponds to the longitudinal axis of the device 1. The axes of symmetry of the fluid connections 2a, 2b and the longitudinal axis of the device 1 are arranged within the central plane of the device 1.

A valve seat element 6 for receiving the valve element 4, for sealing the valve element 4 to the housing 2 and for mechanically guiding the valve element 4 is arranged within the valve chamber 3. Also, a sealing element 7 for sealing the valve seat element 6 to the housing 2 is provided within the valve chamber 3.

The valve element 4 is mounted within the valve seat element 6 so as to be rotatable about the axis of rotation 8. The single sealing element 7, formed as an O-ring, within the valve chamber 3 faces the passage opening of the first fluid connection 2a formed in the housing 2 and is thus arranged between the valve seat element 6 and the housing 2 in the direction of the side wall of the housing 2, corresponding to the position of the first fluid connection 2a. The valve seat element 6 and the sealing element 7, which is in connection with the valve seat element 6 and is formed as an O-ring, together serve as inner sealing elements of the fluid sealing of the valve element 4 to the housing 2.

The valve seat element 6, with the valve element 4 arranged therein and the sealing element 7, can be introduced into the valve chamber 3 through an opening formed in the housing 2 in a direction perpendicularly to the axis of rotation 8 as the central axis and longitudinal axis of the device 1, which corresponds in particular to the axis of symmetry of the first fluid connection 2a. The opening formed in the housing 2 for introducing the components into the valve chamber 3 is closed by means of a closure element 9. The circular closure element 9 has a thread on an outer circumference and is screwed into the housing 2 in the region of the opening. The housing 2 and the closure element 9 are connected to one another in a fluid-tight manner by means of a sealing 10.

The valve element 4, which is arranged within the valve chamber 3 enclosed by the housing 2 and can be rotated about the axis of rotation 8, has an L-shaped through-flow opening 4a which, in the opened state of the device 1, connects the passage openings to one another as flow channels of the fluid connections 2a, 2b.

Due to the formation of the flow path of the device 1 as a two-way valve with an L topology, the housing 2 is closed on a side of the housing 2 opposite the first fluid connection 2a and consequently has no further opening in the form of a fluid connection on the side wall of the housing 2 in addition to the first fluid connection 2a. On the side of the valve element 4 or of the valve seat element 6 opposite the first fluid connection 2a, no sealing element is provided between the housing 2 and the valve seat element 6, so that on the side of the valve element 4 or of the valve seat element 6 opposite the first fluid connection 2a, between the housing 2, the valve element 4 and the valve seat element 6, a cavity 3a connected to the valve chamber 3 is formed as a partial volume of the valve chamber 3.

With a sealing element arranged on the side of the valve element 4 or of the valve seat element 6 opposite the first fluid connection 2a, a closed cavity separated from the valve chamber 3 would be formed as a partial volume of the valve chamber 3. A cavity sealed in this way would be acted upon by fluid during operation of the device. As a result of changing operating conditions, undesired pressure differences of the fluid would occur, which would lead to malfunctions and damage of the device 1. With the cavity 3a connected to the valve chamber 3 on the side of the valve element 4 or the valve seat element 6 opposite the first fluid connection 2a between the housing 2, the valve element 4 and the valve seat element 6 as a partial volume belonging to the valve chamber 3 and not closed off by the valve chamber 3, the mentioned malfunctions and possible damage to the device 1 are avoided.

The device 1 has a drive element, also referred to as an actuator, which is arranged outside the housing 2 and is not represented, which sets a drive shaft, which is formed as an actuator element 11, into a rotational movement 8a about the axis of rotation 8. The actuator element 11 can be driven manually or by means of an electric motor as a drive element, in particular by means of an electric actuating motor. The actuator element 11 is fixedly connected to the valve element 4 at a first end and is coupled to the drive element at a second end formed distally to the first end connected to the valve element 4. The actuator element 11 is arranged in a sealed manner to the housing 2 by a wall of the housing 2 at an end face, projecting into the housing 2. The end face with the actuator element 11 guided through is arranged opposite the end face of the housing 2 formed with the second fluid connection 2b. The axis of symmetry of the second fluid connection 2b and a longitudinal axis of the actuator element 11 are arranged on the longitudinal axis of the device 1.

The actuator can be formed with a gear for the precise adjustment of an angle of rotation of the valve element 4 so that with the help of the actuator, an automated control or regulation of the device 1 can take place.

In the case of an arrangement of the valve element 4 in a first end position, according to FIGS. 2a and 2b, in particular the flow cross-section of the passage opening of the first fluid connection 2a is substantially closed. A fluid connection between the through-flow opening 4a as an inner volume of the valve element 4 and the through-flow opening of the first fluid connection 2a only exists in the region of a groove 12 through which the flow path through the device 1 is opened. The groove 12, also referred to as an expansion notch, is formed on the surface of the valve element 4.

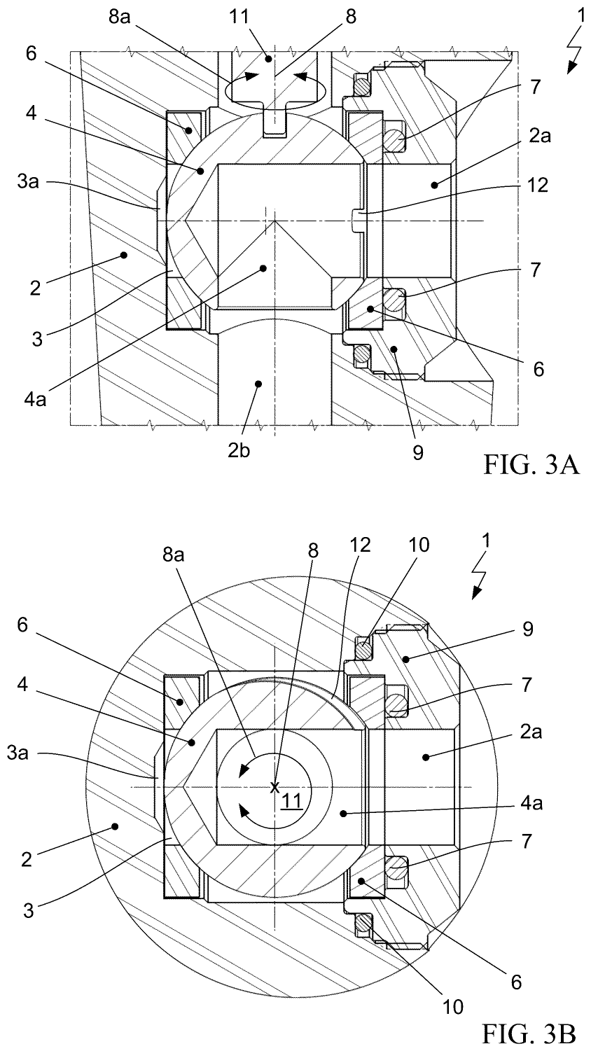

FIGS. 3a and 3b show the device 1 of FIG. 2a in a fully opened state, in particular in a second end position of the valve element 4, in a lateral sectional representation and in a sectional representation of a plan view.

In the second end position of the valve element 4, the valve element 4 is arranged such that the through-flow opening 4a of the valve element 4 connects the through-flow opening of the first fluid connection 2a to the through-flow opening of the second fluid connection 2b. The passage openings of the fluid connections 2a, 2b and the through-flow opening 4a of the valve element 4 are connected to one another such that the flow path through the device 1 is completely opened.

The valve element 4 is continuously movable between the two end positions, in particular rotatable about the axis of rotation 8.

The groove 12 provided as an expansion notch on the surface of the valve element 4 is formed as an elongate depression with an adapted and continuously decreasing depth, extending from the through-flow opening 4a, in particular from the edge of an outflow cross-section of the through-flow opening 4a, on the surface of the valve element 4 in the circumferential direction and in a central plane of the valve element 4 arranged perpendicularly to the axis of rotation 8. The groove 12 is symmetrical with a rectangular cross-section to the central plane of the valve element 4.

The groove 12 has a constant width for a length aligned in the circumferential direction along the central plane, which is aligned orthogonally to the length in the circumferential direction. The depth, which is aligned in each case in the direction orthogonal to the length and to the width and in the radial direction of the valve element 4, decreases steadily and uniformly in the direction of the length starting from the edge of the outflow cross-section. The groove 12 has a maximum depth at the first end, which is arranged at the edge of the outflow cross-section, and a depth of 0 mm at the second end, which is formed distally to the first end of the groove 12.

The device can be formed as a so-called plug-in valve, also referred to as a “drop-in valve”, “insert valve” or “cartridge valve”. The device or a plurality of devices are each inserted into a block, in particular a block formed from aluminium.

List of reference numerals

| | |
|---|---|
| 1, 1′ | device |
| 2, 2‘ | housing |
| 2a, 2a‘ | first fluid connection |
| 2b, 2b′ | second fluid connection |
| 3, 3‘ | valve chamber |
| 3a, 3a‘ | cavity |
| 4, 4‘ | valve element |
| 4a, 4a‘ | through-flow opening of |
| 5′ | holding element |
| 6 | valve seat element |
| 6′ | ring element |
| 7, 7‘ | sealing element |
| 8, 8‘ | axis of rotation |
| 8a | rotational movement |
| 9 | closure element |
| 10 | sealing |
| 11 | actuator element |
| 12 | groove |

What is claimed is:

1. A device for regulating a through-flow and distributing a fluid in a fluid circuit, the device comprising:
a housing with fluid connections, which are each connected via a passage opening to an inner volume of the housing formed as a valve chamber, and
a valve element with a through-flow opening and a valve seat element, which are arranged within the valve chamber, wherein the valve element is mounted rotatably about an axis of rotation within the valve seat element, abutting the valve seat element, wherein the valve seat element is arranged abutting the housing, and wherein exactly one sealing element for sealing the valve seat element to the housing is arranged between the valve seat element and the housing.

2. The device according to claim 1, wherein the housing has two of the fluid connections, a first one of the fluid connections and a second one of the fluid connections.

3. The device according to claim 2, wherein the sealing element is arranged in a region of the first one of the fluid connections facing the passage opening of the first one of the fluid connections formed in the housing.

4. The device according to claim 1, wherein the sealing element is formed as an O-ring.

5. The device according to claim 2, wherein the first one of the fluid connections and the second one of the fluid connections are arranged on sides of the housing which differ from one another, wherein the first one of the fluid connections is formed on a side wall of the housing and the second one of the fluid connections is formed on an end face of the housing.

6. The device according to claim 5, wherein axes of symmetry of the first one of the fluid connections and the second one of the fluid connections are arranged within a common central plane of the device in which also the axis of rotation of the valve element runs.

7. The device according to claim 5, wherein axes of symmetry of the first one of the fluid connections and the second one of the fluid connections are aligned with respect to one another at an angle different from zero.

8. The device according to claim 5, wherein an axis of symmetry of the first one of the fluid connections is aligned perpendicularly to the axis of rotation of the valve element and an axis of symmetry of the second one of the fluid connections is aligned in a direction of the axis of rotation of the valve element.

9. The device according to claim 1, wherein the valve element is formed to be substantially spherical.

10. The device according to claim 1, wherein the through-flow opening of the valve element has an L-shape which, in an opened state of the device, connects the passage opening of each of the fluid connections to one another.

11. The device according to claim 1, wherein the housing has an opening, wherein the valve seat element with the valve element and the sealing element is arranged introduced into the valve chamber through the opening formed in the housing in a direction perpendicularly to the axis of rotation of the valve element.

12. The device according to claim 11, wherein the housing has a closure element for closing the opening in a fluid-tight manner.

13. The device according to claim 12, wherein the sealing element for sealing the valve seat element to the housing is arranged between the valve seat element and the closure element of the housing.

14. The device according to claim 1, wherein the valve element is connected to a drive element arranged outside the housing via an actuator element in order to move the valve element relative to the housing.

15. The device according to claim 14, wherein the actuator element is formed as a drive shaft aligned in a direction of the axis of rotation of the valve element.

16. The device according to claim 15, wherein the actuator element is connected to the valve element at a first end and to the drive element, projecting out of the housing, at a second end formed distally to the first end.

17. The device according to claim 14, wherein the drive element is formed as an actuating motor.

18. The device according to claim 1, wherein the device is formed such that it can be flowed through bidirectionally.

19. A use of the device for regulating the through-flow and distributing the fluid according to claim 1 in a refrigerant circuit of a thermal system of a motor vehicle.
